(19) United States
(12) Patent Application Publication
(10) Pub. No.: US 2017/0220525 A1
(43) Pub. Date: Aug. 3, 2017

(54) METHOD AND APPARATUS FOR HIERARCHICAL DATA ANALYSIS BASED ON MUTUAL CORRELATIONS

(71) Applicant: KONINKLIJKE PHILIPS N.V., EINDHOVEN (NL)

(72) Inventors: CHOO CHIAP CHIAU, SHANGHAI (CN); QI ZHONG LIN, SHANGHAI (CN); TAK MING CHAN, SHANGHAI (CN); YUGANG JIA, WINCHESTER, MA (US)

(73) Assignee: KONINKLIJKE PHILIPS N.V., EINDHOVEN (NL)

(21) Appl. No.: 15/500,934

(22) PCT Filed: Aug. 27, 2015
(86) PCT No.: PCT/EP2015/069574

§ 371 Date: Feb. 1, 2017

(30) Foreign Application Priority Data
Aug. 29, 2014 (CN) PCT/CN2014/085560
Nov. 20, 2014 (EP) 14194063.5

(51) Int. Cl. G06F 17/15; G06F 17/18; G06F 19/00

(52) U.S. Cl. CPC G06F 17/15; G06F 19/3443; G06F 17/18

(57) ABSTRACT

The present invention generally relates to accessing data selected by a user based on correlation analysis. It is proposed in the present invention to introduce attribute value normalization and a hierarchical data analysis based on mutual correlations between attributes. Normalization of scale values of attributes to nominal values provides a basis for the hypothesis of correlations between attributes, thus scientifically justifying further observation and comparison. Multiple layer hierarchical investigation enables not only analysis on the level of attributes but also of related data, which provides a more detailed observation.

### FIELD OF THE INVENTION

The present invention generally relates to accessing data of interest based on correlation analysis, particularly clinical data of interest based on correlation analysis of mass data.

### BACKGROUND OF THE INVENTION

Nowadays, the prevailing electronic information systems in hospitals enable collecting mass data for analysis. Correlation is a crucial analysis method to investigate the mutual impacts between data collected for generating new knowledge which is useful for observation, prediction, diagnosis and other purposes. However, data extracted from a data base of data types (e.g. numerical, nominal etc.) needs to be processed using different kinds of correlation calculation methods, which are not suitable for comparison. Furthermore, such a large quantity of information, for example CVIS (Cardiovascular Information System) with over 200 data attributes per patient, requires a well-designed structure to present the data and correlations between them to a user interested in investigating the respective characteristics and impacts.

US Patent 2013/0138592A1 discloses a method for mass data processing to generate a relation graph by using the plurality of attributes and extract a sub-graph from the relationship graph to represent a hypothesis, where the correlation is generated based on dependency classifications of data attributes. Besides, the correlation value, expressed as p value, is used to uniformly represent correlation estimated by different statistical tests, which is decided depending on the specific data types of related attributes. However, although the correlation value, expressed as p-value, can be generated from various statistical tests addressing different hypotheses, the so-called unified correlation value does not reflect consistent quantitative values or hypotheses, and thus is not sound for comparisons. Dependency classifications do reduce the correlations provided, thereby enhancing user convenience, but they also restrain the investigations into potential dependencies of data types and miss part of the information contained in data. Furthermore, no hierarchical analysis is provided for data processing and all data processing is carried out on attribute level, making analysis inefficient and incomplete.

US Patent 2012/215455A1 discloses a method, which involves receiving at least one location signal with the communications module, storing geospatial data obtained from the location signal with a time stamp in a memory and receiving biomedical signals over time from a sensor with the communication module. Biomedical data from the received biosignal is stored with a time stamp in the memory. The receiving of location signal and storing of geospatial data from the location are repeated in different geographic locations.

“The use of multiple correspondence analysis to explore associations between categories of qualitative variables in healthy ageing” (Patricio Soares Costa et al., Journal of aging research, vol. 2013, 302163, 2013, XP55190591) disclosed a study to illustrate the applicability of multiple correspondence analysis (MCA) in detecting and representing underlying structures in large datasets used to investigate cognitive aging.

### SUMMARY OF THE INVENTION

Therefore, it would be desirable to provide an efficient method and apparatus to facilitate full investigations into data and present the information of user interest in a clear and simple way.

To better address one or more of these concerns, according to an embodiment of one aspect of the invention, an apparatus and method for hierarchical data analysis based on mutual correlations is provided.

An apparatus for data analysis based on mutual correlations, the data comprising a plurality of attributes, the apparatus comprising:
a normalizer adapted for normalizing attributes of each data in a data set to nominal values;
a calculator adapted for calculating correlations between the attributes of each data in the data set, based on the normalized nominal values of the attributes;
a first generator adapted for generating a first graph of categories and correlations between the categories, each category comprising classified attributes based on predefined rules, each correlation between the categories being the average correlation between attributes of respective categories; or generating a first graph of recommended attributes;
a second generator adapted for generating a second graph of a first attribute selected by user from the first graph, related attributes and the correlations between the first attribute and the related attributes, the correlation between the first attribute and each related attribute being above a predefined correlation threshold;
a third generator adapted for generating a third graph of statistical distribution of the related data, based on the values of the first attribute and at least a second attribute selected by user from the second graph, the related data comprising the first attribute and at least the second attribute.

The statistical distributions are presented in a coordinate plain, where each value combination of the attributes of the first attribute and at least the second attribute and corresponding statistics to each value combination are represented by axis values and at least a distinguishing visual property of a statistical indicator, the statistical indicator indicating the value combination of the attributes of the first attribute and at least the second attribute and the statistics corresponding to the value combination.

It is proposed in the present invention to introduce the normalization of the values of attributes and a hierarchical analysis apparatus for data analysis, based on mutual correlations between attributes. The normalization of the scale values of attributes to nominal values provides a basis for the hypothesis of correlations of attributes, making further observation and comparison scientifically justified. The multiple layer hierarchic investigation enables not only analysis on attribute level but also analysis into related data, which provides a more detailed observation, which makes the mass data analysis efficient and complete.

In one embodiment, the normalization is based on domain knowledge.

The normalization of the scale values into nominal values based on domain knowledge makes the data analysis medically more meaningful and efficient. Instead of scale values, the nominal values give a direct and simple definition of the status of the attribute, such as “Normal” or “Abnormal”, which makes the analysis better perceivable.

In one embodiment, the recommendation is based on the selection frequency or on medical guidelines.

In one embodiment, the apparatus further comprises a fourth generator adapted for generating a list of related data, based on the values selected by a user of the first attribute and at least the second attribute, the related data comprising the first attribute and at least the second attribute.

The apparatus provides one additional layer to look into the content of related data, which completes the full investigation of categories of attributes/top attributes, attributes, related data and data content. It enables the user to make full use of all information contained in the data available.

In one embodiment, the correlation between two attributes is presented by a correlation indicator connecting the two attributes, the visual property of the correlation indicator being based on the correlation value.

The instant visualization of the correlation value, by means of a (?) visual property of each correlation indicator, between attributes facilitates a convenient understanding of the complicated relationship between attributes.

The invention comprises a method of data analysis based on mutual correlations, the data comprising a plurality of attributes, (?), the method comprising:
normalizing attributes of each data in a data set to nominal values;
calculating correlations between the attributes of each data in the data set, based on the normalized nominal values of the attributes;
generating a first graph of categories and correlations between the categories, each category comprising classified attributes based on predefined rules, each correlation between the categories being the average correlation between attributes of respective categories; or generating a first graph of recommended attributes;
generating a second graph of a first attribute selected by user from the first graph, related attributes and the correlations between the first attribute and the related attributes, the correlation between the first attribute and each related attribute being above a predefined correlation threshold;
generating a third graph of statistical distribution of the related data, based on the values of the first attribute and at least a second attribute selected by user from the second graph, the related data comprising the first attribute and at least the second attribute.

Various aspects and features of the disclosure are described in further detail below. And other objects and advantages of the present invention will become more apparent and will be easily understood from the description and with reference to the accompanying drawings.

### DESCRIPTION OF THE DRAWINGS

The present invention will be described and explained hereinafter in more detail in combination with embodiments and with reference to the drawings, wherein:

FIG. 1 is a schematic diagram showing an apparatus for 3 layer data analysis based on mutual correlations of an embodiment of the invention;

FIG. 2 is a schematic diagram showing a third graph of recommended attributes.

FIG. 3(a) is a schematic diagram showing a third graph of categories of attributes and correlations between the categories.

FIG. 3(b) is a schematic diagram showing a third graph of categories of attributes and correlations between the categories, where the attributes of the selected categories are further displayed.

FIG. 4(a) is a schematic diagram showing a first graph of a first attribute, related attributes and the correlations between the first attribute and first related attributes.

FIG. 4(b) is a schematic diagram showing a second graph of statistics of the related data based on the value of a second attribute of the first graph, the related data comprising the first attribute and the second attribute.

FIG. 5(a) is a schematic diagram showing a first graph of a first attribute, related attributes and the correlations between the first attribute and first related attributes.

FIG. 5(b) is a schematic diagram showing a second graph of statistics of the related data based on the values of a second attribute and a third attribute of the first graph, the related data comprising the first attribute, the second attribute and the third attribute.

FIG. 6 is a schematic diagram showing a method for 3 layer data analysis based on mutual correlations of an embodiment of the invention;

The same reference signs in the drawings indicate similar or corresponding features and/or functionalities.

### DETAILED DESCRIPTION

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn to scale for illustrative purposes.

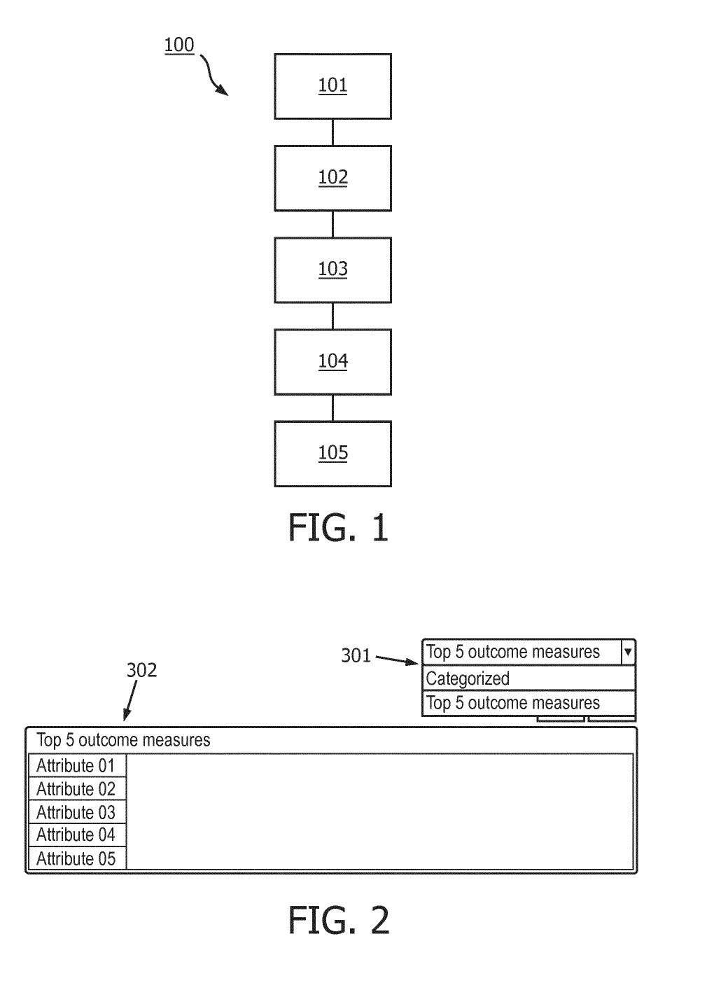

FIG. 1 is a schematic diagram showing an apparatus for 3 layer (categories/recommended-attribute-data) data analysis based on mutual correlations according to an embodiment of the invention to investigate into the mutual impacts. The clinical data for the analysis of the present invention comprises a plurality of attributes, each of which contains one item of demographic information, life style information, medical information, care provider information, history and risk factor information, previous visit information, procedure information, etc. of a specific patient. The medical information includes a patient's basic health information, lesion information, device information and follow-up information. The value of each attribute can be either nominal or scale type. The nominal type is a kind of value which is not consecutive, not measurable and not distinguishable as to magnitude. For example, most demographic information such as gender, hometown, employment status and some medical history information like medicine type, lesion type, device used is nominal, which cannot be measured numerically. The scale type, by contrast, is a kind of value which is consecutive, measurable and distinguishable as to magnitude. For example, demographic information such as age and medical history information such as dose of the medicine, lesion description parameters is scale-type information, which can be measured numerically. Multiple data as described above constitute a data set as the analysis object of the present invention. Normalizer 101 normalizes the values of all attributes into nominal values under a unified standard to provide a universally comparable basis for further analysis. The unified standard is based on the domain knowledge. For example, scale values are transformed to be “normal” and “abnormal” according to the clinical guideline, such as the American College of Cardiology (ACC) guideline, and/or input by the cardiologists considering the local standards. With guidelines and/or expert input, extra attributes can be derived from combining multiple attributes, e.g. the nominal CTO result (successful/failed/no CTO) can be derived from whether CTO was performed (Yes/No) and whether the post-procedure, biomarker, TIMI, is 3. With the unified standardization (scale values transformed into nominal values), the values of the attributes are generated under one hypothesis related to all attributes, proving a justified basis for correlation analysis of the attributes. Based on the converted values of the attributes, the calculator 102 calculates the correlations between attributes. The statistical methods suitable for nominal values can be adopted for the calculations, such as the Chi-square test method, Fisher's exact test method, binomial test method, Kruskal-Wallis test method, etc. The correlations generated based on the universal hypothesis for all attributes are scientifically meaningful and comparable.

A first generator 103 generates a first graph of categories and correlations between the categories. The attributes are classified into categories based on predefined rules or the data registry categorization, which can be based on the definition of the clinical activities, information related to economic factors, lifestyle classification, follow-up information, history and risk factors, anatomy information, lesion information, device information, incident/complication information, etc. Then the categories and correlations between them are presented to give an overview of the dependent relations for the categories. The correlations between categories are based on the correlation values of the attributes classified to each category. As for one implementation, the average correlation value between the attributes classified to each category can be utilized to represent the correlation between categories. After one category is selected, the attributes of the category selected by user are displayed. The categories of attributes are implemented as a top layer being processed (?) for data analysis, which reduces the choices for selections and observations. Together with the further display of attributes of the category of interest, the analysis procedure becomes more efficient for the user in terms of finding the attribute of his interest. As an alternative, the first layer for data analysis can also be implemented as a list of limited recommended attributes, e.g. from clinical recommendation, expert suggestions, or computational short-listing according to correlation or other criteria. Additionally, a pre-processor of data can be adopted to unify the structure of data as a prerequisite for data analysis. Various electronic information systems are available for use in a hospital, such as CIS (Clinical Information System), LIS (Laboratory Information System), RIS (Radiology Information System) etc., which results in various data formats. As for data analysis across different information systems, a unified structure is desired to provide a common basis for all data, thus enabling correlation analysis of a certain attribute for all data. The unified structure can be designed as an integration of all attributes possible for the available information systems, and value stuffing will be performed to form the new unified data for the missing attributes compared to the original ones. For example, zero can be stuffed into the attributes missing for the new generated data.

A second generator 104 generates a second graph of a first attribute, related attributes and the correlations between the first attribute and first related attributes. The first attribute is an attribute selected by a user out of preference. The related attributes are the attributes whose correlations with the first (?) attribute are above a predefined correlation threshold. For example, the correlation value of a statistical method suitable for nominal values is presented by statistical significance as p-values and a generally accepted threshold is set at 0.05. The correlations between them are presented for further investigation. What is offered is a visualization of the attribute selected by user and its related attributes in a clear and simple way.

A third generator 105 generates a third graph of statistical distribution of the related data based on the values of the first attribute and at least a second attribute of the second graph selected by user, where the related data comprises the first attribute and at least the second attribute. The second generator 104 implements a detailed investigation into the data related to the attributes selected by user, providing more information of related data from a statistical point of view. A fourth generator (not illustrated in FIG. 1) can be deployed to present a data list based on the value selected by user for the first attribute, the second attribute and/or the third attribute.

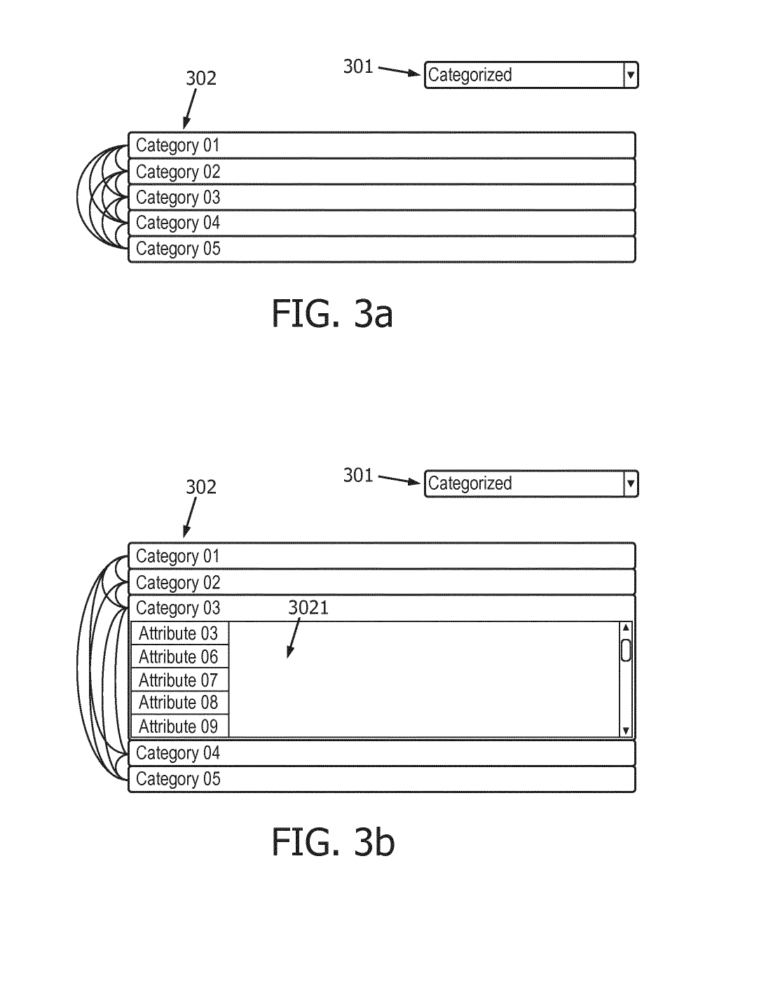

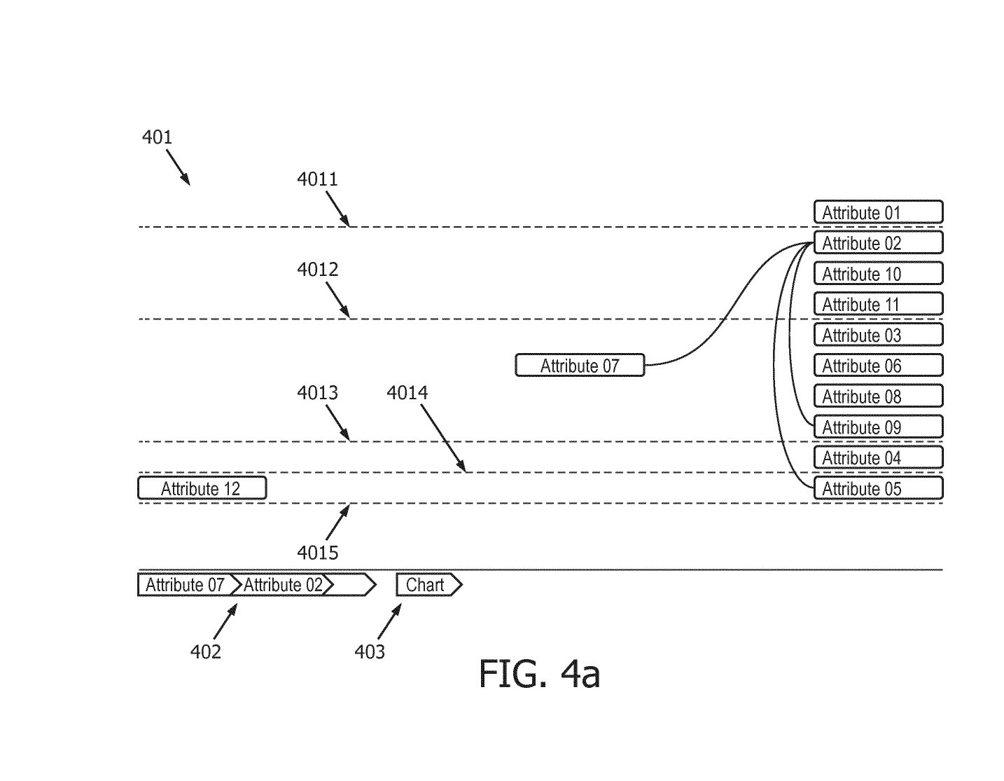

FIG. 2, FIG. 3(a) and FIG. 3(b) are an implementation of the user interface of the third-layer data analysis. FIG. 2 is a schematic diagram showing a first graph of recommended attributes. A selection window 301 is set for the choice of the third-layer analysis, which can either be top 5 outcome measures or categorized. As for top 5 outcome measures, they are recommended based on predefined rules, for example based on the frequency with which they are selected or on medical guidelines. Then the display area 302 present according to attributes (attribute 01˜attribute 05) is recommended. FIG. 3(a) and FIG. 3(b) are schematic diagrams showing a first graph of categories of attributes, correlations between the categories, and they further display attributes of the category selected by a user. If the category is chosen through selection window 301, all attributes are presented in classified categories (category 01˜category 05) for a user to choose for his preference. And the correlations between the categories are presented in correlation indicators connecting both categories. The correlation indicators of the embodiment are in the form of lines. The thickness of the lines represents the correlation value between categories. Categories with too weak a correlation, that is below a certain threshold, will have no connecting lines. For example, the line between category 02 and category 05 is thinner than the line between category 02 and category 04, which indicates category 02 has a stronger correlation with category 04 than with category 05. The correlation value can be presented also by other visual properties or other shapes of indicators. The visual properties can be color, brightness, filling pattern or others. The shapes can be bars, chains or others. After one category, for example category 03, is chosen, a list 3021 of all attributes (attribute 03, attribute 06, attribute 07, attribute 08, attribute 09) classified to the category 03 is displayed under the category 03 for further selection by a user, who, in this case, selects attribute 07 selected. FIG. 2, FIG. 3(a) and FIG. 3(b) is an embodiment of the top layer of the data analysis hierarchy to enhance the efficiency.

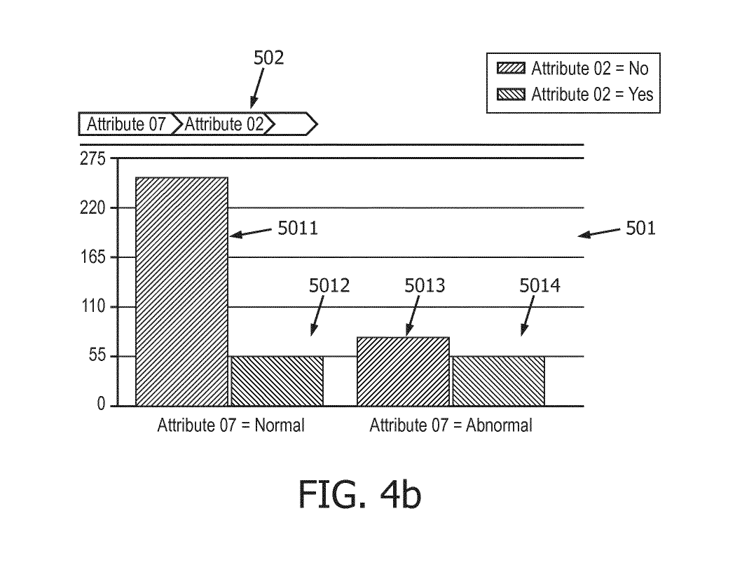

FIG. 4(a) and FIG. 4(b) are an implementation of the user interface of the second and third layer data analysis with the first attribute and second attribute selected by a user. FIG. 4(a) is a schematic diagram showing a second graph of a first attribute, related attributes and the correlations between the first attribute and related attributes. The interface includes an attribute display area 401, an attribute selection display window 402 and chart button 403. The attribute display area 401 is used to display the generated first graph. The first attribute selected by user is attribute 07, which is located in the center. Each area segmented by dotted lines 4011˜4015 is assigned to the related attributes of one category, sorted according to certain criteria, e.g. ascending statistical significance in one embodiment. For example, the area segmented by dotted line 4012 and dotted line 4013 is the area assigned to the related attributes of category 03 (attribute 03, attribute 06, attribute 07, attribute 08, attribute 09). Furthermore, the classified related attributes are scattered on both sides. The related attributes located on the left side are the attributes correlating only with the attribute 07 selected by user. The related attributes located on the right side are the attributes correlating with multiple attributes including the attribute 07 selected by user. Then, the attribute 02 is selected as the second attribute selected by user from the second graph. Before any attribute is selected in FIG. 4(a), hovering over the attributes will trigger the detailed information (e.g. statistical significance such as p-value and correlation strength) to be displayed along the lines (not shown in the figure). Whenever an attribute is selected as an attribute selected by user, it will be displayed in the attribute selection display window 402. The chart button 403 enables to show the statistical distribution of related attributes. FIG. 4(b) shows a third graph of statistics of the related data, based on the value of a first attribute selected from the first graph, a second attribute selected from the second graph and the related data comprising the first attribute, where the related data comprises the first attribute and the second attribute. The interface includes a statistical distribution display area 501 and an attribute selection display window 502. The chart is a bar chart based on different values of the attribute 07 and the attribute 02. The value of attribute 07 is either “Normal” or “Abnormal” and the value of attribute 02 is either “Yes” or “No”, which results in four combinations. And the according, related data distributions presented by bar-shaped statistical indicators 5011˜5014 for four combinations, respectively, are shown in a coordinate plane, where the y-axis represents the number of related data for corresponding combinations, the x-axis represent the value of the first attribute 07 and the color represents the value of the second attribute 02. Further action can be conducted to show the list of data of a certain combination selected by user (not illustrated) for investigation. The action can be implemented by clicking on the bar indicators representing the combination or input from the user.

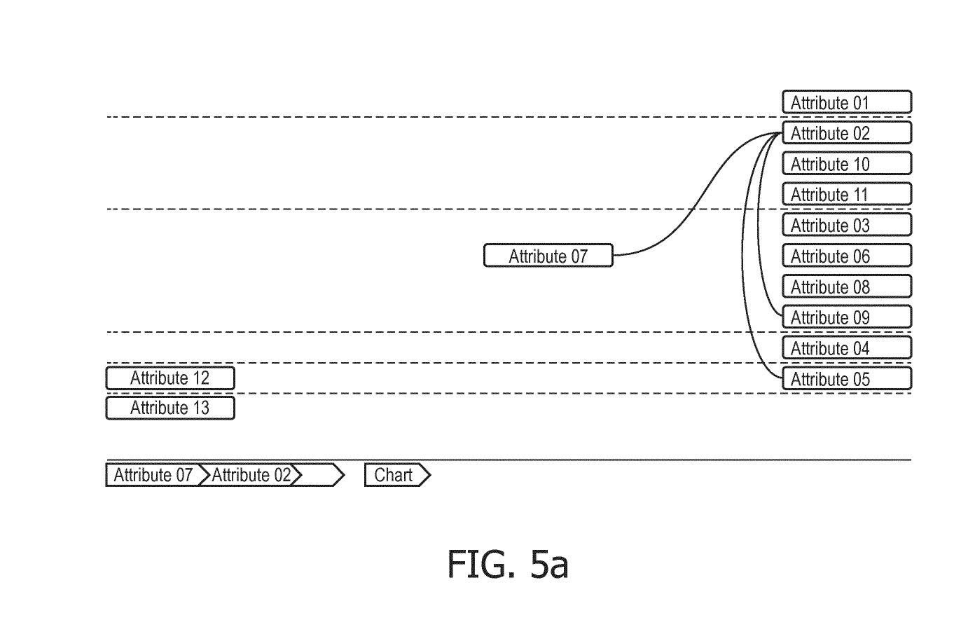

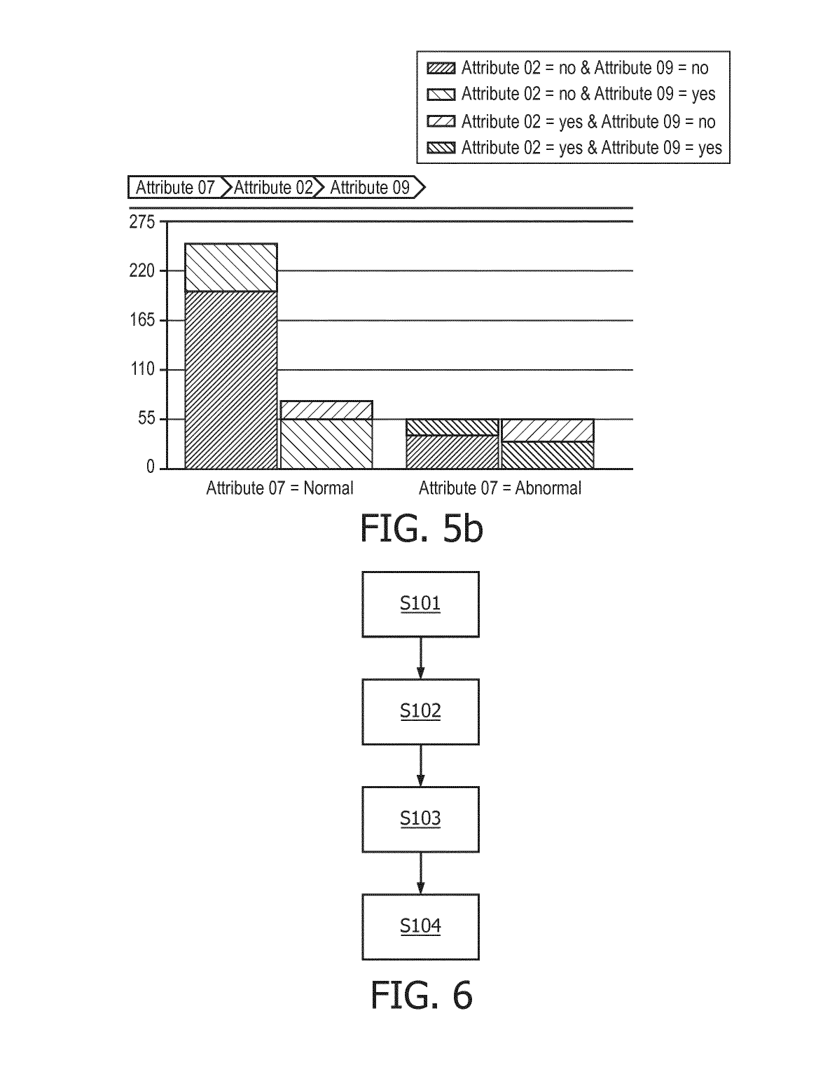

FIG. 5(a) and FIG. 5(b) are an implementation of the user interface of the first and second layer data analysis with the first attribute, second attribute and third attribute selected by user. For FIG. 6(a), the only difference is that a third attribute selected by user is selected, where the third attribute selected by user is the attribute 09 whose value is either “yes” or “no”. This results in eight combinations. For FIG. 5(b), the according, related data distributions and 8 combinations are shown in a coordinate plane, where the y-axis represents the number of related data for corresponding combinations, the x-axis represents the value of the first attribute and the color represents the value of the second and third attribute.

More attributes related to the first attribute can be involved for statistical distribution analysis and more visual properties of statistical properties, such as intensity and fill-in pattern, can be utilized to represent more combinations of values of the attributes.

FIG. 6 is a schematic diagram showing a method for 3 layer data analysis based on mutual correlations in an embodiment of the invention The invention comprises a method of data analysis based on mutual correlations, the data comprising a plurality of attributes, the method comprising:
Step 101: normalizing attributes of each data in a data set to nominal values;
Step 102: calculating correlations between the attributes of each data in the data set, based on the normalized nominal values of the attributes;
Step 103: generating a first graph of categories and correlations between the categories, each category comprising classified attributes based on predefined rules, each correlation between the categories being the average correlation between attributes of respective categories; or generating a first graph of recommended attributes;
Step 104: generating a second graph of a first attribute selected by user from the first graph, related attributes and the correlations between the first attribute and the related attributes, the correlation between the first attribute and each related attribute being above a predefined correlation threshold;
Step 105: generating a third graph of statistical distribution of the related data, based on the values of the first attribute and at least a second attribute selected by user from the second graph, the related data comprising the first attribute and at least the second attribute

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An apparatus for hierarchical data analysis based on mutual correlations, the data comprising a plurality of attributes, the apparatus comprising:
a normalizer adapted for normalizing attributes of each data in a data set to nominal values;
a calculator adapted for calculating correlations between the attributes of each data in the data set, based on the normalized nominal values of the attributes;
a first generator adapted for generating a first graph of categories and correlations between the categories, each category comprising classified attributes based on predefined rules, each correlation between the categories being the average correlation between attributes of respective categories; or generating a first graph of recommended attributes;
a second generator adapted for generating a second graph of a first attribute selected by user from the first graph, correlated attributes and the correlations between the first attribute and the correlated attributes, the correlation between the first attribute and each correlated attribute being above a predefined correlation threshold;
a third generator adapted for generating a third graph of statistical distribution of the correlated data, based on the values of the first attribute and at least a second attribute selected by user from the second graph, the correlated data comprising the first attribute and at least the second attribute;
wherein the data is medical data.

2. The apparatus according to claim 1, wherein the nominal values are determined based on diagnostic rules predefined, wherein the redefined diagnostic rule defines the mapping between nominal values and scale values of the attribute of each data.

3. The apparatus according to claim 1, wherein the attribute of the first graph are recommended according to the selection frequency of each attribute by user.

4. The apparatus according to claim 1, further comprising a fourth generator adapted for generating a list of correlated data, based on the values selected by user of the first attribute and at least the second attribute, the related data comprising the first attribute and at least the second attribute.

5. The apparatus according to claim 1, wherein the correlation between two categories or attributes is presented by a correlation indicator connecting the two categories or attributes, the visual property of the correlation indicator being based on the value of the correlation between the two categories or attributes.

6. A method of hierarchical data analysis based on mutual correlations, the data comprising a plurality of attributes, the method comprising the steps of:
normalizing attributes of each data in a data set to nominal values;
calculating correlations between the attributes of each data in the data set, based on the normalized nominal values of the attributes;
generating a first graph of categories and correlations between the categories, each category comprising classified attributes based on predefined rules, each correlation between the categories being the average correlation between attributes of respective categories; or generating a first graph of recommended attributes;
generating a second graph of a first attribute selected by user from the first graph, correlated attributes and the correlations between the first attribute and the correlated attributes, the correlation between the first attribute and each correlated attribute being above a predefined correlation threshold;
generating a third graph of statistical distribution of the correlated data, based on the values of the first attribute and at least a second attribute selected by user from the second graph, the correlated data comprising the first attribute and at least the second attribute;
wherein the data is medical data.

7. The method according to claim 6, wherein the nominal values are determined based on diagnostic rules predefined, wherein the predefined diagnostic rules define the mapping between nominal values and scale values of the attribute of each data.

8. The method according to claim 6, wherein the attribute of the first graph are recommended according to the selection frequency of each attribute by user.

9. The method according to claim 6, further comprising a step of generating a list of related data, based on the values of the first attribute and at least the second attribute, the related data comprising the first attribute and at least the second attribute.

10. The method according to claim 6, wherein the correlation between two categories or attributes is presented by a correlation indicator connecting the two categories or attributes, the visual property of the correlation indicator being based on the value of the correlation between the two categories or attributes.

11. A computer program product comprising computer program code means for causing a computer to perform the steps of the method as claimed in claim 6 when said computer program code means is run on the computer, wherein the computer comprises a display.
